(19) United States
(12) Patent Application Publication
(10) Pub. No.: US 2017/0223160 A1
(43) Pub. Date: Aug. 3, 2017

(54) WEARABLE DEVICE WITH AN ANTENNA SYSTEM

(71) Applicant: LOGITECH EUROPE, S.A., LAUSANNE (CH)

(72) Inventors: STEPHEN DUDDY, Moama (AU); AHMAD SHAMSODDINI, Salt Lake City, UT (US)

(21) Appl. No.: 15/012,823

(22) Filed: Feb. 1, 2016

(51) Int. Cl. H04M 1/02; H01Q 1/38

(52) U.S. Cl. CPC H04M 1/0277; H01Q 1/38

(57) ABSTRACT

A wearable device and methods for using the same provided. In one embodiment, a wearable device includes an antenna configured as part of earphones, a controller and/or a band. The antenna may be an electrically conductive layer and may be enclosed within the same printed circuit board (PCB) as other components such as processor, transceiver, and/or battery.

### TECHNICAL FIELD

The present disclosure relates generally an antenna, and more particularly to an antenna integrated with a wearable electronic device.

### BACKGROUND

Wearable electronic devices continue to grow in popularity and have become an integral part of personal communication. Wearable electronic devices may allow users to wirelessly receive high-fidelity audio data for playback and but may also track a user's fitness level, for example, by counting the user's steps, total calories burned, miles run, etc., and by monitoring the user's heart rate almost anywhere they travel. Moreover, as wearable electronic device technology has increased, so too has the functionality of wearable electronic devices. As such, Moreover, such multi-function wearable devices may require users to wirelessly access the Internet via a cellular network and/or a wireless local area network (WLAN), for example.

Even so, as the functionality of wearable electronic devices continues to increase, so too does the demand for smaller devices which are easier and more convenient for users to carry. One challenge this poses for wearable device manufacturers is designing housings that cooperate with antennas to provide desired operating characteristics within the relatively limited amount of space available.

### BRIEF DESCRIPTION

In view of the above drawbacks, there is a long-felt need for wearable electronic devices to include an internal antenna configured to receive and transmit electromagnetic signal. Further, there is a long-felt need for such devices to remain sleek, mobile, lightweight. In one embodiment of the disclosure, in which the wearable device is a wearable fitness-monitoring device, being sleek, mobile, lightweight, and/or rugged allows a user to perform numerous activities while wearing the device. Moreover, antenna enables transmission and collection of data, such as data relating to the user's activity and the user's physical responses thereto, thus enabling the user to better track a multitude of fitness-and-health related data points. Additionally, there is a long-felt-need for wearable devices that are simple and cheap to manufacture.

Various embodiments of the present disclosure include a wearable device configured with an internal antenna. In one embodiment, the wearable device includes earphones with a controller attached to each earphone via a cable and an band. The antenna may be placed inside individual earphones, controller, or band. The antenna may be enclosed within the same printed circuit board (PCB) as other components such as processor, transceiver, and/or battery. The antenna may be configured as an electrically conductive layer and may define a perimeter of the wearable device. Additionally, the wearable device itself may function as an antenna. The antenna may be limited to a fixed range of frequencies or may be configured to operate at a certain gain, frequency, bandwidth, and radiation pattern shape. The antenna may be formed from electrically conductive material such as metal or other electrically conductive materials including, plastic, glass, metal, ceramic composites, or other suitable materials. In other embodiments, the antenna may be configured as an electrically conductive coating on another part of the wearable device, for example inside the earphone. The antenna may be coupled to a battery or may comprise a separate power source.

Other features and aspects of the disclosed method and system will become apparent from the following detailed description, taken in conjunction with the accompanying drawings, which illustrate, by way of example, the features in accordance with embodiments of the disclosure. The summary is not intended to limit the scope of the claimed disclosure, which is defined solely by the claims attached hereto.

### BRIEF DESCRIPTION OF THE DRAWINGS

The present disclosure, in accordance with one or more various embodiments, is described in detail with reference to the following Figures. The Figures are provided for purposes of illustration only and merely depict typical or example embodiments of the disclosure.

FIG. 1 illustrates an example communications environment in which embodiments of the disclosed technology may be implemented.

FIG. 2A illustrates a perspective view of exemplary earphones according to embodiments of the present disclosure.

FIG. 2B illustrates an example architecture for circuitry of earphones according to embodiments of the present disclosure.

FIG. 3A illustrates a perspective view of an example earphone controller according to embodiments of the present disclosure.

FIG. 3B illustrates a perspective view of an example earphone controller assembly according to embodiments of the present disclosure.

FIG. 4 illustrates a cross-sectional view of an example electronic capsule the may be used in connection with the example band, in accordance with various embodiments.

### DETAILED DESCRIPTION

The technology disclosed herein is directed toward an antenna integrated into a wearable device. In addition to wirelessly receiving high-fidelity audio data for playback, the disclosed earphones may collect the user's biometric data such as heartrate data and movement data, and wirelessly transmit the biometric data to a computing device for processing and user-interaction using an activity tracking application installed on the computing device.

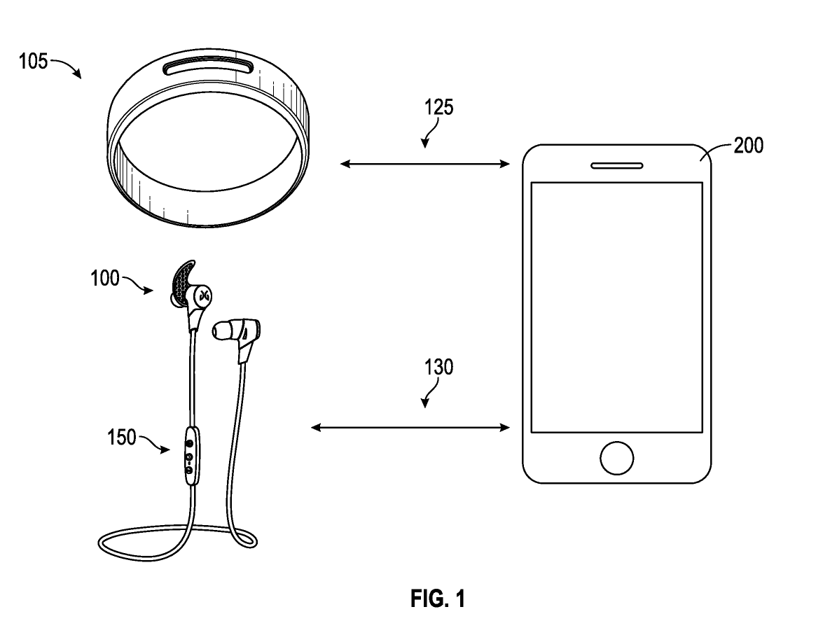

FIG. 1 illustrates an example communications environment in which embodiments of the disclosed technology may be implemented. In this embodiment, earphones 100 communicate biometric and audio data with computing device over a communication link 130. The biometric data is measured by one or more sensors (e.g., heart rate sensor, accelerometer, gyroscope) of earphones 100. Although a smartphone is illustrated, computing device 200 may comprise any computing device (smartphone, tablet, laptop, smartwatch, desktop, etc.) configured to transmit audio data to earphones 100, receive biometric data from earphones 100 (e.g., heartrate and motion data), and process the biometric data collected by earphones 100. In additional embodiments, computing device 200 itself may collect additional biometric information that is provided for display. For example, if computing device 200 is a smartphone, it may use built in accelerometers, gyroscopes, and a GPS to collect additional biometric data.

Computing device 200 additionally includes a graphical user interface (GUI) to perform functions such as accepting user input and displaying processed biometric data to the user. The GUI may be provided by various operating systems known in the art, such as, for example, iOS, Android, Windows Mobile, Windows, Mac OS, Chrome OS, Linux, Unix, a gaming platform OS, etc. The biometric information displayed to the user can include, for example a summary of the user's activities, a summary of the user's fitness levels, activity recommendations for the day, the user's heart rate and heart rate variability (HRV), and other activity related information. User input that can be accepted on the GUI can include inputs for interacting with an activity tracking application further described below.

In preferred embodiments, the communication link 130 is a wireless communication link based on one or more wireless communication protocols such as BLUETOOTH, ZIGBEE, 802.11 protocols, Infrared (IR), Radio Frequency (RF), etc. Alternatively, the communications link 130 may be a wired link (e.g., using any combination of an audio cable, a USB cable, etc.)

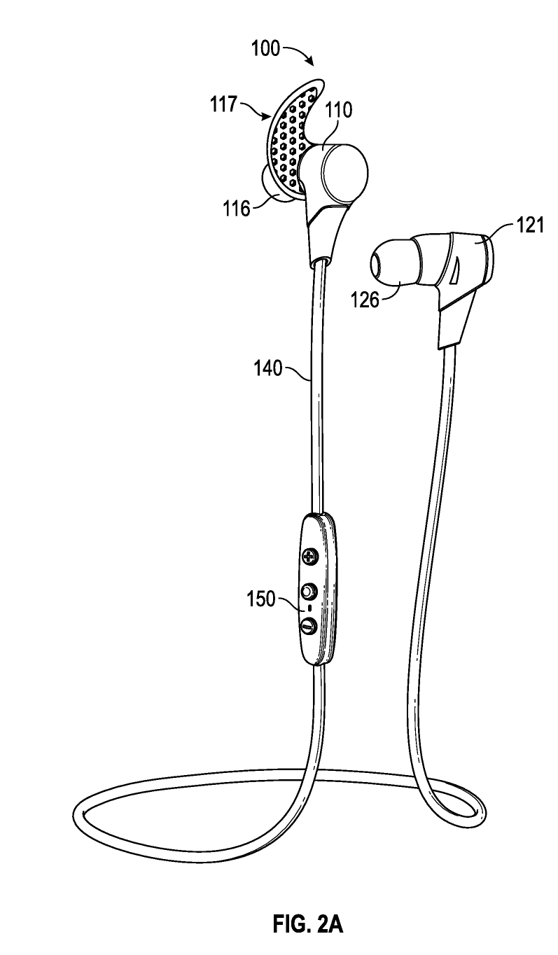

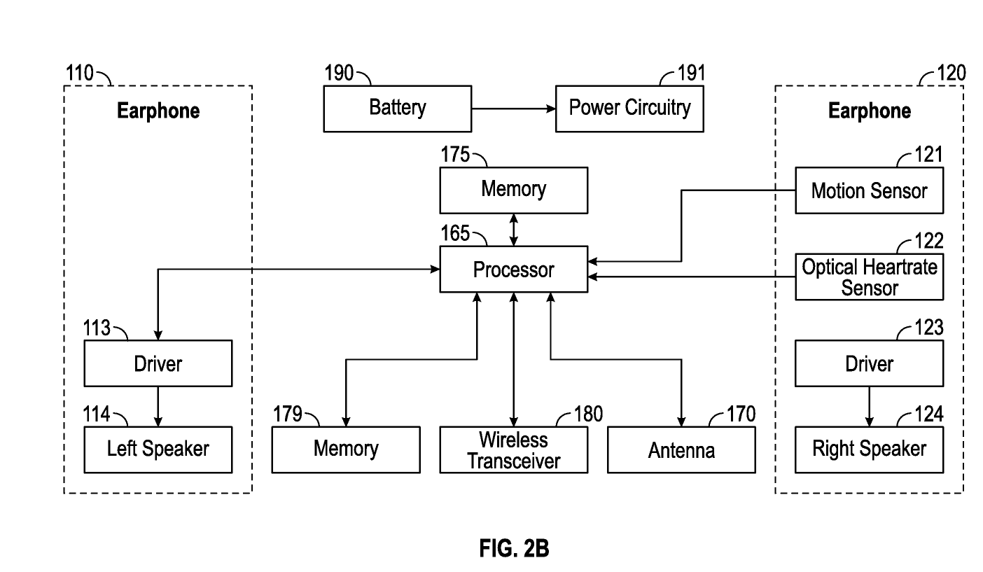

With specific reference now to earphones 100, FIG. 2A is a diagram illustrating a perspective view of exemplary earphones 100. FIG. 2A will be described in conjunction with FIG. 2B, which is a diagram illustrating an example architecture for circuitry of earphones 100. Earphones 100 comprise a right earphone 110 with tip 116, a left earphone 120 with tip 126, a controller 150 and a cable 140. Cable 140 electrically couples the right earphone 110 to the left earphone 120, and both earphones 110-120 to controller 150. Additionally, each earphone may optionally include a fin or ear cushion 117 that contacts folds in the outer ear anatomy to further secure the earphone to the wearer's ear.

In embodiments, earphones 100 may be constructed with different dimensions, including different diameters, widths, and thicknesses, in order to accommodate different human ear sizes and different preferences. In some embodiments of earphones 100, the housing of each earphone 110, 120 is rigid shell that surrounds electronic components. For example, the electronic components may include motion sensor 121, optical heartrate sensor 122, audio-electronic components such as drivers 113, 123, and speakers 114, 124, and other circuitry (e.g., processor 165 and memories 179, 175). The rigid shell may be made with plastic, metal, rubber, or other materials known in the art. The housing may be cubic shaped, prism shaped, tubular shaped, cylindrical shaped, or otherwise shaped to house the electronic components.

The tips 116, 126 may be shaped to be rounded, parabolic, and/or semi-spherical, such that it comfortably and securely fits within a wearer's outer ear, with the distal end of the tip contacting an outer rim of the wearer's outer ear canal. In some embodiments, the tip may be removable such that it may be exchanged with alternate tips of varying dimensions, colors, or designs to accommodate a wearer's preference and/or fit more closely to match the radial profile of the wearer's outer ear canal. The tip may be made with softer materials such as rubber, silicone, fabric, or other materials, as would be appreciated by one of ordinary skill in the art.

In some embodiments, controller 150 may provide various controls (e.g., buttons and switches) related to audio playback, such as, for example, volume adjustment, track skipping, audio track pausing, and the like. Additionally, controller 150 may include various controls related to biometric data gathering, such as, for example, controls for enabling or disabling heart rate and motion detection. In a particular embodiment, controller 150 may be a three button controller.

The circuitry of earphones 100 includes processor 165, memory 175, wireless transceiver 180, circuity for earphones 110 and earphone 120, antenna 170, and a battery 190. In this embodiment, earphone 120 includes a motion sensor 121 (e.g., an accelerometer or gyroscope), an optical heartrate sensor 122, and a right speaker 124 and corresponding driver 123. Earphone 110 includes a left speaker 114 and corresponding driver 113. In additional embodiments, earphone 110 may also include a motion sensor such as an accelerometer or gyroscope.

A biometric processor 165 comprises logical circuits dedicated to receiving, processing, and storing biometric information collected by the biometric sensors of the earphones. More particularly, as illustrated in FIG. 2, processor 165 is electrically coupled to motion sensor 121 and optical heartrate sensor 122, and receives and processes electrical signals generated by these sensors. These processed electrical signals represent biometric information such as the earphone wearer's motion and heartrate. Processor 165 may store the processed signals as biometric data in memory 175, which may be subsequently made available to a computing device using wireless transceiver 180. In some embodiments, sufficient memory is provided to store biometric data for transmission to a computing device for further processing.

During operation, optical heartrate sensor 122 uses a photoplethysmogram (PPG) to optically obtain the user's heart rate. In one embodiment, optical heart rate sensor 122 includes a pulse oximeter that detects blood oxygenation level changes as changes in coloration at the surface of a user's skin. More particularly, heartrate sensor 120 illuminates the skin of the user's ear with a light-emitting diode (LED). The light penetrates through the epidermal layers of the skin to underlying blood vessels. A portion of the light is absorbed and a portion is reflected back. The light reflected back through the skin of the user's ear is then obtained with a receiver (e.g., a photodiode) and used to determine changes in the user's blood oxygen saturation (SpO₂) and pulse rate, thereby permitting calculation of the user's heart rate using algorithms known in the art (e.g., using processor 165). In this embodiment, the optical sensor may be positioned on one of the earphones to face radially inward towards an earlobe when the earphones are worn by a human user.

In various embodiments, optical heartrate sensor 122 may also be used to estimate a heart rate variable (HRV), i.e. the variation in time interval between consecutive heartbeats, of the user of earphones 100. For example, processor 165 may calculate the HRV using the data collected by sensor 122 based on a time domain methods, frequency domain methods, and other methods known in the art that calculate HRV based on data such as the mean heart rate, the change in pulse rate over a time interval, and other data used in the art to estimate HRV.

In further embodiments, logic circuits of processor 165 may further detect, calculate, and store metrics such as the amount of physical activity, sleep, or rest over a period of time, or the amount of time without physical activity over a period of time. The logic circuits may use the HRV, the metrics, or some combination thereof to calculate a recovery score. In various embodiments, the recovery score may indicate the user's physical condition and aptitude for further physical activity for the current day. For example, the logic circuits may detect the amount of physical activity and the amount of sleep a user experienced over the last 48 hours, combine those metrics with the user's HRV, and calculate a recovery score. In various embodiments, the calculated recovery score may be based on any scale or range, such as, for example, a range between 1 and 10, a range between 1 and 100, or a range between 0% and 100%.

During audio playback, earphones 100 wirelessly receive audio data using wireless transceiver 180. The audio data is processed by logic circuits of audio processor 160 into electrical signals that are delivered to respective drivers 113 and 123 of left speaker 114 and right speaker 124 of earphones 110 and 120. The electrical signals are then converted to sound using the drivers. Any driver technologies known in the art or later developed may be used. For example, moving coil drivers, electrostatic drivers, electret drivers, orthodynamic drivers, and other transducer technologies may be used to generate playback sound.

The wireless transceiver 180 is configured to communicate biometric and audio data using available wireless communications standards. For example, in some embodiments, the wireless transceiver 180 may be a BLUETOOTH transmitter, a ZIGBEE transmitter, a Wi-Fi transmitter, a GPS transmitter, a cellular transmitter, or some combination thereof. Although FIG. 2 illustrates a single wireless transceiver 180 for both transmitting biometric data and receiving audio data, in an alternative embodiment, a transmitter dedicated to transmitting only biometric data to a computing device may be used. In this alternative embodiment, the transmitter may be a low energy transmitter such as a near field communications (NFC) transmitter or a BLUETOOTH low energy (LE) transmitter. In implementations of this particular embodiment, a separate wireless receiver may be provided for receiving high fidelity audio data from an audio source. In yet additional embodiments, a wired interface (e.g., micro-USB) may be used for communicating data stored in memories 165 and 175.

FIG. 2B shows an antenna 170 that may be enclosed in the earphone 110, earphone 120, or enclosed in the controller 150 connected to each earphone 110 and 120 via a cable. The antenna 170 may function as a transmitting antenna, receiving antenna or transceiver antenna, depending on the intended use of the earphones 100.

In an embodiment, processor 165, wireless transceiver 180, and battery 190 may be enclosed in and distributed throughout any one of earphone 110, earphone 120, and controller 150. For example, in one particular embodiment, processor 165 and transceiver 180 may be enclosed in earphone 120 along with the antenna 170. In this particular embodiment, these components are electrically coupled to the same printed circuit board (PCB) enclosed in earphone 120.

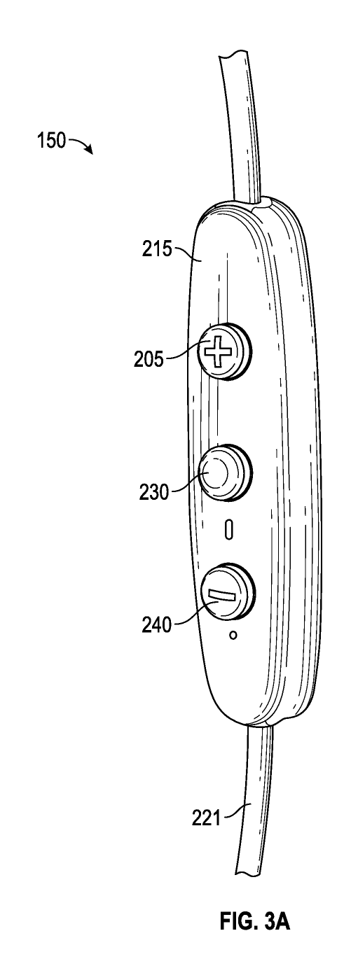

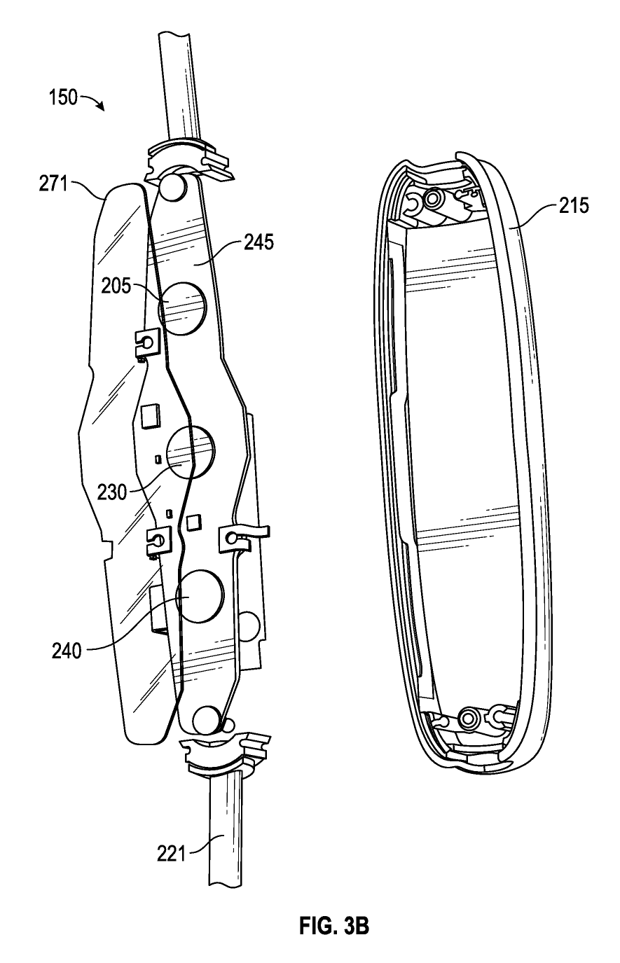

The antenna 170 may be configured as an electrically conductive layer 271 as illustrated in FIG. 3B. By way of example, the electrically conductive layer 271 may be regular or irregular in shape. The electrically conductive layer 271 may define a perimeter of each earphone 110, earphone 120, controller 150, or band 105.

In certain embodiments, the PCB carried by the earphone 120 may include a wireless transceiver 180 coupled to the electrically conductive layer 271 of the antenna 170. The electrically conductive layer 271 of the antenna 170 may be coupled to the PCB via at least one connection point. The connection point may be used to configure the frequency band at which antenna is configured to operate. In a certain embodiment, one or more desired antenna operating parameters such as gain, operating frequency, bandwidth, radiation pattern shape may be configured via the connection point. The frequency of operation of the antenna 170 may be limited to a fixed range of frequencies. The wireless transceiver circuitry may be configured to operate in the 800 MHz to 3.25 GHz frequency band, for example.

The PCB and the electrically conductive layer 271 of the antenna 170 may be positioned such as to include an air gap therebetween. The PCB and the electrically conductive layer 271 may further include a dielectric material body between the PCB and the electrically conductive layer 271. The air gap between the antenna 170 and the PCB may be regular or irregular in shape. The air gap may between the antenna 170 and the PCB may be uniform. The air gap between the antenna 170 and the PCB may vary in diameter, width, and thicknesses. The antenna 170 may be placed on a PCB or may be configured as an electrically conductive coating on another part of the wearable device, for example, inside the earphone 120.

One or more gaps may be formed within the electrically conductive layer 271 of the antenna 170. Such gaps may be filled with dielectric material such as plastic and may interrupt the otherwise continuous shape of electrically conductive layer 271. The electrically conductive layer 271 may have any suitable number of gaps (e.g., more than one, more than two, three or more, less than three, etc.).

The electrically conductive layer 271 of the antenna 170 may be formed from a durable material such as metal. Metals such as stainless steel or other metals may be used if desired. In another embodiment, the electrically conductive layer 271 of the antenna 170 may be formed from plastic, glass, metal, ceramic composites, or other suitable materials. Furthermore, the antenna 170 may consist of a coating electrically conductive paint or electrically conductive film may be deposited inside the earphone 120.

FIG. 2B also shows that the electrical components of headphones 100 are powered by a battery 190 coupled to power circuitry 191. Any suitable battery or power supply technologies known in the art or later developed may be used. For example, a lithium-ion battery, aluminum-ion battery, piezo or vibration energy harvesters, photovoltaic cells, inductor charger, USB battery charger, or other like devices can be used. In embodiments, battery 190 may be enclosed in earphone 110, earphone 120, or enclosed in the controller 150 connected to each earphone 110 and 120 via a cable. In another embodiment, the electrically conductive layer 271 of the antenna 170 may fully or partially enclose power circuitry 191 and battery 190.

A processor 165 may also be carried by the PCB. The processor may cooperate with the other components, for example, the antenna 170 and the wireless transceiver 180 to coordinate and control operations of the headphones 100. Operations may include wirelessly receiving audio data.

The earphones 100 may include an electrically conductive portion. For example, the electrically conductive portion may be metallic or include a metallic portion. In a certain embodiment, the electrically conductive portion the earphones 100 may be configured to operate as an antenna. The electrically conductive portion of the earphones 100 may transmit or receive at different operating frequencies, for example, cellular telephone, satellite, or other wireless communications frequencies. The earphones 100 may include an additional or second antenna coupled to the wireless transceiver 180. The second antenna may also be configured to transmit or receive signal at different operating frequencies, for example, cellular telephone, satellite, or other wireless communications frequencies, and may operate independently or in conjunction with the electrically conductive portion of the earphones 100 that is configured as an antenna.

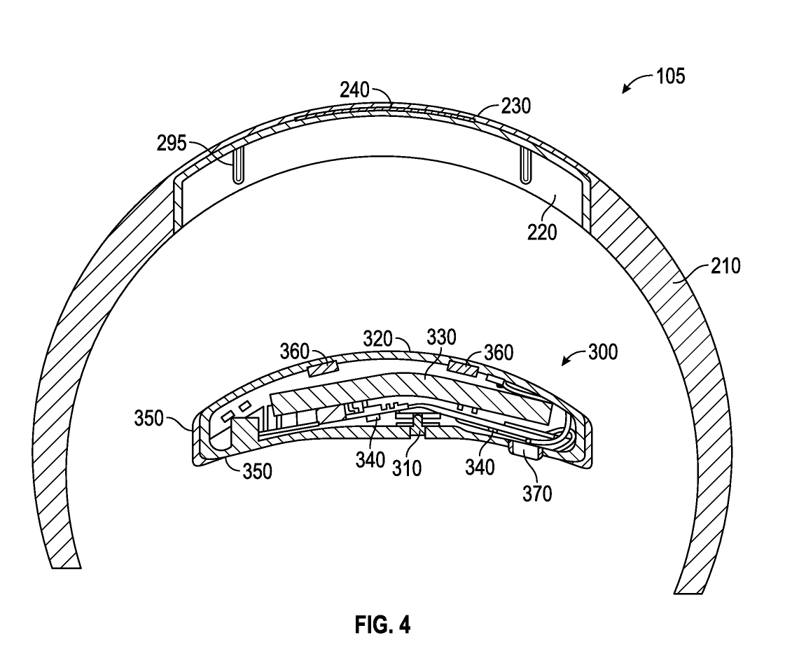

Alternatives to the embodiments are shown in FIGS. 3A, 3B, and 4. In particular, FIG. 3A illustrates a perspective view of an example earphone controller 150 in a detached configuration. As illustrated, a controller 150 is connected to each earphone 110, 120 via a cable 221. The controller may include various control buttons 205, 230, 240 to control or adjust various functions of the earphones. By way of example only, control button 205 may increase the audio volume and control button 235 may decrease the audio volume projected from the earphones 100. By way of another example only, control button 230 may play/pause the audio by clicking or tapping the button once or even fast forward a song when the control button 230 is tapped twice quickly. However, it should be noted that the buttons 205, 230, 240 are not merely limited to increasing volume or pausing/fast forwarding audio. Instead, control buttons 205, 230, 240 may provide a variety of control functions (e.g., receive incoming call, ignore incoming call, capture a photo, record biometric data, enable or disable heart rate and motion detection, etc.) depending on the type of computing device the earphone is configured to communicate biometric and/or audio data over communication link 130. Furthermore, controller 150 may include various buttons that are not limited to a three button controller, and instead, may include one button, two buttons, four buttons, etc.

In one embodiment, the controller 150 may include one or more modules that may be in the form of electronic capsules embedded within the controller 150. Such modules may include devices such as accelerometers, gyroscopes, processors, logic circuits, biosensors, optical sensors, batteries, circuit boards, modems, amplifiers, wireless transceivers (e.g., GPS, Wi-Fi, Bluetooth, cellular, etc.), integrated circuits, antennae, and the like.

FIG. 3B illustrates a perspective view of an example earphone controller 150 assembly shown as removed from its case 215. The case 215 housing various control buttons 205, 230, 240 to control or adjust various functions of the earphones are depicted outside of the case 215. In some embodiments, the controller 150 may include an antenna 270 on the inside of the controller case 215. In a certain embodiment, antenna 270 may be part of the control button panel 245. The antenna 270 may function as a transmitting antenna, receiving antenna or transceiver antenna, depending on the intended use of the controller 150. In another embodiment, the antenna 170 may be configured as an electrically conductive layer 271 and form the entirety of the case 215. In another embodiment, the controller 150 may itself be configured to function as an antenna.

FIG. 4 depicts an exploded cross-sectional view of example embodiments of band 105. FIG. 43 illustrates a perspective view of band 105. As depicted, band 105 includes band portion 210 and electronic capsule 300, which includes various electronic components embodied therein. Electronic capsule 300 is a removable/detachable component that may be coupled to and removable/detachable from band portion 210. This may be accomplished in a variety of ways, e.g., magnetic attraction forces, snap-fit/friction, etc. In other cases, electronic capsule 300 may be integrally formed with band portion 210.

Electronic capsule 300 may include various components, such as battery 330, logic circuits 340, casing 350, one or more of wrist biosensor 310, finger biosensor 320, and/or a motion sensor (e.g., accelerometer, gyroscope, magnetometer, or other inertial measurement unit), and an antenna 370. Typically, at least one of wrist biosensor 310 and finger biosensor 320 is a heart rate sensor configured to detect the heart rate of a wearer of band 105. In the illustrated embodiment, finger biosensor 320 protrudes outwardly from a first side (i.e., the top) of casing 350, and wrist biosensor protrudes outwardly from a second side (i.e., the bottom) of casing 350. As depicted, aperture 230 of band portion 210 substantially matches the dimensional profile of finger biosensor 320, such that finger biosensor 320 may be exposed and accessible to the touch of a user's finger through aperture 230 when band 105 is worn by the user. In various embodiments, battery 330, logic circuits 340, and an optional motion sensor are enclosed inside of casing 350. Battery 330 is electronically coupled and supplies power to logic circuits 340. By way of example, logic circuits 340 may by implemented using printed circuit boards (PCBs).

In some embodiments, the antenna 370 may be configured as an electrically conductive layer 271 as illustrated in FIG. 3B and may be positioned within the band portion 210. In other embodiments, antenna 370 may be part of the electronic capsule 300. Electrically conductive layer 271 may be integrated with the PCBs or may be embedded within the casing 350. In another embodiment, the casing 350 may itself be configured to function as an antenna. The antenna 370 may function as a transmitting antenna, receiving antenna or transceiver antenna, depending on the intended use of the band 105.

Casing 350 may be made of various materials known in the art, including, for example, molded plastic, silicone, rubber, or another moldable material. Additionally, casing 350 may be sealing using an ultrasonic welding process to be substantially water tight, thus protecting electronic capsule 300 from the elements. Further, band 105 may be configured to encircle a wrist or other limb (e.g., ankle, etc.) of a human or other animal or object. In one embodiment, band 105 is adjustable in size/fit. In some embodiments, cavity 220 is notched on the radially inward facing side of band 105 and shaped to substantially the same dimensions as the profile of electronic capsule 300. In addition, aperture 230 may be located in the material of band 105 within cavity 220. Aperture 230 may be shaped to substantially the same dimensions as the profile of the finger biosensor 320. As shown, cavity 220 and aperture 230 are in combination designed to detachably couple to electronic capsule 300 such that, when electronic capsule 300 is positioned inside cavity 220, finger biosensor 320 protrudes at least partially into aperture 230 such that electronic capsule 300 may be exposed to the touch of a user's finger. Electronic capsule 300 may further include one or more magnets 360 configured to secure electronic capsule 300 in cavity 220. Magnets 360 may be concealed in casing 350. Alternatively, cavity 220 may be configured to conceal magnets 360 when electronic capsule 300 detachably couples in cavity 220 and aperture 230.

Band 105 may further include a ferromagnetic metal strip 240 concealed in band portion 210 within cavity 220. In such a case, when electronic capsule 300 is positioned within cavity 220, magnets 360 are attracted to ferromagnetic metal strip 240 and pull electronic capsule 300 radially outward with respect to band portion 210. The force provided by magnets 360 may detachably secure electronic capsule 300 inside cavity 220. In alternative embodiments, electronic capsule 300 may be positioned inside cavity 220 and be affixed therein using a form-fit, press-fit, snap-fit, friction-fit, VELCRO, or other temporary adhesion or attachment technology.

In some embodiments, logic circuits 340 include an a motion sensor that includes an inertial measurement unit (e.g., one or more of a gyroscope, accelerometer, and magnetometer, etc.), a wireless transmitter, and additional circuitry. Logic circuits 340 may be configured to process electronic signals from biosensors (e.g., finger biosensor 320 and wrist biosensor 310) and/or motion sensors, convert/store the electronic signals as data, and output the data via the transmitter (e.g., using wireless protocols described herein). In other scenarios, this data may be output using a wired connection (e.g., USB, fiber optic, HDMI, or the like).

Referring again to electronic capsule 300, in some embodiments, the electronic signals processed by logic circuits 340 include an activation time signal and a recovery time signal. In these embodiments, logic circuits 340 may process the electronic signals to calculate an activation recovery interval equal to the difference between the activation time signal and the recovery time signal. The electronic of signals may include heart rate information collected by and received from one or more of the wrist biosensor 310 and finger biosensor 320. Further still the electronic signals may include electro-cardio signals from a user's heart. In these embodiments, logic circuits 340 may process the electro-cardio signals to calculate and store a RR-interval and determine a heart rate. The RR-interval may be the delta in time between two R-waves, where the R-waves are the electro-cardio signals generated by a ventricle contraction in the heart. The RR-interval may further be used to calculate and store a heart rate variability (HRV) value that indicates the variation over time of the time delta between consecutive heartbeats. In some embodiments, logic circuits 340 may convey the electronic signals to, e.g., computing device 200, by a transmitter, such that computing device 200 may perform various calculations (e.g., of HRV).

In some instances, finger biosensor 320 and wrist biosensor 310 may be replaced or supplemented by a single biosensor configured to detect and measure biometric information. The single biosensor may be an optical biosensor such as a pulse oximeter configured to detect blood oxygen saturation levels. The pulse oximeter may output an electronic signal to logic circuits 340 indicating a detected cardiac cycle phase and/or heart rate, and logic circuits 340 may use such information (e.g. the cardiac cycle phase data) to further calculate an HRV value, or logic circuits 340 may convey the information to, e.g., computing device 200, by a transmitter, such that computing device 200 may perform various calculations (e.g., of HRV). Logic circuits 340, in some deployments, may further detect and store metrics based on motion detection, such as the amount of physical activity, sleep, or rest, over a period of time, or the amount of time with or without physical activity over a period of time.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of example block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various example embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

1. A wearable device configured for wireless transmission, the device comprising:
an antenna configured to receive and transmit an RF signal, wherein the antenna is formed from an electrically conductive continuous layer;
a printed circuit board (PCB) coupled to the antenna via at least one connection point and configured to receive and process the RF signal from the antenna;
a transceiver coupled to the antenna;
a processor coupled to the transceiver; and
a non-transitory computer-readable medium operatively coupled to the processor and storing instructions that, when executed, cause the processor to adjust a frequency, a bandwidth, and a radiation pattern of the antenna based on a configuration of the electrically conductive continuous layer from which the antenna is formed.

2. The wearable device of claim 1, wherein the wearable device further comprises one of earphones, a controller, and a band.

3. The wearable device of claim of claim 1, wherein the antenna is positioned on the inside of the wearable device.

4. The wearable device of claim of claim 1, wherein the antenna is positioned on the outside of the wearable device.

5. The wearable device of claim of claim 1, wherein the electrically conductive continuous layer is made of any of a conductive metal vapor material, a conductive polymer material, a conductive paint material and a conductive film material.

6. The wearable device of claim of claim 1, wherein the electrically conductive continuous layer and the PCB are positioned to include an air gap between them.

7. The wearable device of claim of claim 1, wherein the electrically conductive continuous layer includes at least one non-conductive gap filled with a non-conductive material.

8. The wearable device of claim of claim 1, wherein a frequency of a received or transmitted RF signal comprises a carrier frequency in a wireless system operating according to Bluetooth standards.

9. The wearable device of claim of claim 1, wherein the electrically conductive continuous layer is configured to be part of the PCB.

10. The wearable device of claim of claim 1, wherein the wearable device is configured to operate as the antenna.

11. The wearable device of claim of claim 1, wherein the antenna is further configured to operate in the 2.4 GHz frequency band.

12. The wearable device of claim of claim 1, wherein the antenna further comprises a power source configured to power the antenna.

13. A system for wireless transmission, the system comprising:
a wearable device configured for wireless transmission;
an antenna configured to receive and transmit an RF signal, wherein the antenna is formed from an electrically conductive continuous layer;
a printed circuit board (PCB) coupled to the antenna via at least one connection point and configured to receive and process the RF signal from the antenna;
a transceiver coupled to the antenna;
a processor coupled to the transceiver; and
a non-transitory computer-readable medium operatively coupled to the processor and storing instructions that, when executed, cause the processor to adjust a frequency, a bandwidth, and a radiation pattern of the antenna based on positioning of the antenna in or on the wearable device or configurations of the electrically conductive continuous layer from which the antenna is formed.

14. The system of claim 13, wherein the wearable device comprises one of earphones, a controller, and a band.

15. The system of claim 13, wherein the antenna is positioned on the inside of the wearable device.

16. The system of claim 13, wherein the antenna is positioned on the outside of the wearable device.

17. The system of claim 13, wherein the electrically conductive continuous layer is made of any of a conductive metal vapor material, a conductive polymer material, a conductive paint material and a conductive film material.

18. The system of claim 13, wherein the electrically conductive continuous layer and the PCB are positioned to include an air gap between them.

19. The system of claim 13, wherein the electrically conductive continuous layer includes at least one non-conductive gap filled with a non-conductive material.

20. The system of claim 13, wherein a frequency of a received or transmitted RF signal comprises a carrier frequency in a wireless system operating according to Bluetooth standards.

21. The system of claim 13, wherein the electrically conductive continuous layer is configured to be part of the PCB.

22. The system of claim 13, wherein the wearable device is configured to operate as the antenna.

23. The system of claim 13, wherein the antenna is further configured to operate in the 2.4 GHz frequency band.

24. The system of claim 13, wherein the antenna further comprises a power source configured to power the antenna.
